(19) United States
(12) Patent Application Publication
(10) Pub. No.: US 2012/0207011 A1
(43) Pub. Date: Aug. 16, 2012

(54) METHOD AND APPARATUS FOR RESPONDING TO AN UNRECOVERABLE ERROR

(75) Inventors: Steven Franklin, Guildford (GB); Keiichi Kubota, Weybridge (GB)

(73) Assignee: Renesas Mobile Corporation, Tokyo (JP)

(21) Appl. No.: 13/025,298

(22) Filed: Feb. 11, 2011

(51) Int. Cl. H04W 24/00

(52) U.S. Cl. 370/216; 370/242

(57) ABSTRACT

A method, apparatus and computer product are provided that may respond to an unrecoverable error without initiating a cell update procedure. In an instance in which more than one connection is concurrently supported in either the circuit switched domain, the packet switched domain or both, the method, apparatus and computer program product may avoid interrupting or terminating the connection that did not experience the unrecoverable error. For example, in an instance in which the unrecoverable error occurred on a radio bearer for a data service connection, such as a packet switched data call, the method, apparatus and computer program product may address the unrecoverable error without disruption of a connection for a voice service, such as a circuit switched voice call.

### TECHNOLOGICAL FIELD

Embodiments of the present invention relate generally to wireless communication technology, and more particularly, to a method, apparatus and computer program product for responding to an unrecoverable error without initiating a cell update procedure.

### BACKGROUND

A number of wireless technologies provide for support of connections in both the circuit switched (CS) domain and the packet switched (PS) domain. In some instances, a user of a mobile terminal may concurrently establish connections in both the packet switched domain and the circuit switched domain such that, for example, a circuit switched voice call and a packet switched data call are conducted simultaneously. While voice communication may be provided via the circuit switched voice call in the foregoing example, various services may be provided by the packet switched data call, such as file downloading.

The packet switched domain generally supports the transmission of larger transport block sizes between a mobile terminal and a network than does the circuit switched domain. For example, circuit switched voice service may utilize a relatively small transport block size, such as up to 244 bits in an instance in which a narrow band adaptive multi-rate (ARM) codec is utilized. As an example of the typically larger transport block sizes utilized by the packet switched domain, a packet switched data service may support transport block sizes of 27,952 bits in an instance in which the mobile terminal supports high-speed downlink shared channel (HS-DSCH) category 10.

In some instances, an unrecoverable error, such as a radio link control (RLC) unrecoverable error, may occur on the connection that is established in the packet switched domain or the circuit switched domain. As a result of the larger transport block sizes utilized by packet switched services in comparison to circuit switched services, these unrecoverable errors generally occur in the packet switched domain more often than in the circuit switched domain, particularly in a relatively weak field.

In an instance in which an unrecoverable error, such as an RLC unrecoverable error is detected by the mobile terminal, the mobile terminal may initiate a cell update procedure, such as in accordance with the third generation partnership project (3GPP) standard. During a cell update procedure, any service supported by either the circuit switched domain or the packet switched domain is at least temporarily disrupted since all dedicated resources are temporarily released during the cell update procedure. Further, a service, such as a circuit switched service or a packet switched service, may be dropped during the cell update procedure if the respective service does not support a call re-establishment procedure. Thus, the initiation of a cell update procedure may create at least a disruption, if not a complete termination, of the connection in the circuit switched domain, such as the connection supporting a circuit switched voice call, even though the unrecoverable error occurred in the packet switched domain and was otherwise unrelated to the circuit switched service.

### BRIEF SUMMARY OF EXAMPLE EMBODIMENTS

A method, apparatus and computer product are therefore provided that may respond to an unrecoverable error without initiating a cell update procedure. As such, in an instance in which more than one connection is concurrently supported in either the circuit switched domain or the packet switched domain or both, the method, apparatus and computer program product of some embodiments may avoid interrupting or terminating the connection that did not experience the unrecoverable error. For example, in an instance in which the unrecoverable error occurred on a radio bearer for a data service connection, such as a packet switched domain data call, the method, apparatus and computer program product of some embodiments may address the unrecoverable error without disruption of a connection for a voice call, such as a circuit switched voice call.

In one example embodiment, a method is provided that concurrently supports first and second different types of services via first and second radio access bearers, respectively. The method may also include causing a report to be issued to a network in response to an unrecoverable error that is experienced on a radio bearer of one of the radio bearers. The report may identify at least one of the radio bearer that experienced the unrecoverable error or a core network domain associated with the radio bearer that experienced the unrecoverable error. In accordance with some embodiments, the report may identify a cause of the unrecoverable error. In any event, the report is caused to be issued without initiating a cell update procedure.

The method of one embodiment may also re-establish a radio bearer following issuance of the report to the network. In this regard, the method may determine a START value for the radio bearer that is to be re-established and cause a message to be communicated to the network that includes the START value. Prior to re-establishing the radio bearer, the method may also receive a message from the network indicating either the radio bearer to be re-established or the core network domain associated with the radio bearer to be re-established. The method of one embodiment may also receive a message from the network indicating that the network supports unrecoverable error reporting. In this embodiment, the message is received from the network prior to causing the report to be issued.

In another example embodiment, an apparatus is provided that includes processing circuitry configured to at least concurrently support first and second different types of services via first and second radio access bearers, respectively. The processing circuitry may also be configured to cause a report to be issued to a network in response to an unrecoverable error that is experienced on a radio bearer of one of the radio bearers. The report may identify at least one of the radio bearer that experienced the unrecoverable error or a core network domain associated with the radio bearer that experienced the unrecoverable error. In accordance with some embodiments, the report may identify a cause of the unrecoverable error. In any event, the report is caused to be issued without initiating a cell update procedure.

The processing circuitry of one embodiment may also be configured to re-establish a radio bearer following issuance of the report to the network. In this regard, the processing circuitry may be configured to determine a START value for the radio bearer that is to be re-established and to cause a message to be communicated to the network that includes the START value. Prior to re-establishing the radio bearer, the processing circuitry may also be configured to receive a message from the network indicating either the radio bearer to be re-established or the core network domain associated with the radio bearer to be re-established. The processing circuitry of one embodiment may also be configured to receive a message from the network indicating that the network supports unrecoverable error reporting. In this embodiment, the message is received from the network prior to causing the report to be issued.

In one example embodiment, a computer program product is provided that includes at least one computer-readable storage medium having computer-executable program code instructions stored therein. The computer-executable program code instructions may include program code instructions for concurrently supporting first and second different types of services via first and second radio access bearers, respectively. The computer-executable program code instructions may also include program code instructions for causing a report to be issued to a network in response to an unrecoverable error that is experienced on a radio bearer of one of the radio access bearers. The report may identify at least one of the radio bearer that experienced the unrecoverable error and a core network domain associated with the radio bearer that experienced the unrecoverable error. In accordance with some embodiments, the report is caused to be issued without initiating a cell update procedure.

In another example embodiment, an apparatus is provided that includes means for concurrently supporting first and second different types of services via first and second radio access bearers, respectively. The apparatus may also include means for causing a report to be issued to a network in response to an unrecoverable error that is experienced on a radio bearer of one of the radio bearers. The report may identify at least one of a radio bearer that experienced the unrecoverable error and a core network domain associated with the radio bearer that experienced the unrecoverable error. In accordance with some embodiments, the report is caused to be issued without initiating a cell update procedure.

In a further example embodiment, an apparatus is provided that includes processing circuitry configured to at least receive a report in an instance in which a mobile terminal that has been concurrently supporting first and second different types of services via first and second radio access bearers, respectively, has experienced an unrecoverable error on a radio bearer of one of the radio access bearers. In this regard, the report identifies at least one of the radio bearer that experienced the unrecoverable error or a core network domain associated with the radio bearer that experienced the unrecoverable error. The processing circuitry of this example embodiment may also be configured to cause the radio bearer that experienced the unrecoverable error to be released without initiation of a cell update procedure.

The processing circuitry of one embodiment may be configured to cause the radio bearer that experienced the unrecoverable error to be released by causing all radio bearers, other than a signaling radio bearer, that are associated with the core network domain to be released in an instance in which the report identifies the core network domain. The processing circuitry may be configured to receive a message that includes a START value for a radio bearer to be re-established and to apply the START value to the radio bearer that is re-established. Prior to re-establishment of the radio bearer, the processing circuitry may also be configured to cause a message to be communicated to the mobile terminal indicating either the radio bearer to be re-established or the core network domain associated with the radio bearer to be re-established. The processing circuitry of one embodiment may also cause a message to be communicated to the mobile terminal indicating support for unrecoverable error reporting. This message may be caused to be communicated prior to receiving the report.

In another example embodiment, a method is provided that includes receiving a report in an instance in which a mobile terminal that has been concurrently supporting first and second different types of services via first and second radio access bearers, respectively, has experienced an unrecoverable error on a radio bearer of one of the radio access bearers. In this regard, the report may identify at least one of a radio bearer that experienced the unrecoverable error or a core network domain associated with the radio bearer that experienced the unrecoverable error. The method of this example embodiment may also include causing the radio bearer that experienced the unrecoverable error to be released without initiation of a cell update procedure.

In a further example embodiment, a computer program product is provided that includes at least one computer-readable storage medium having computer-executable program code instructions stored therein. The computer-executable program code instructions may include program code instructions for receiving a report in an instance in which a mobile terminal that has been concurrently supporting first and second different types of services via first and second radio access bearers, respectively, has experienced an unrecoverable error on a radio bearer of one of the radio access bearers. In this regard, the report identifies at least one of a radio bearer that experienced the unrecoverable error or a core network domain associated with the radio bearer that experienced the unrecoverable error. The computer-executable program code instructions of this example embodiment may also include program code instructions for causing the radio bearer that experienced the unrecoverable error to be released without initiation of a cell update procedure.

In yet another example embodiment, an apparatus is provided that includes means for receiving a report in an instance in which a mobile terminal that has been concurrently supporting first and second different types of services via first and second radio access bearers, respectively, has experienced an unrecoverable error on a radio bearer of one of the radio access bearers. In this regard, the report may identify at least one of a radio bearer that experienced the unrecoverable error or a core network domain associated with the radio bearer that experienced the unrecoverable error. The apparatus of this example embodiment may also include means for causing the radio bearer that experienced the unrecoverable error to be released without initiation of a cell update procedure.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates one example of a communication system according to an embodiment of the present invention;

FIG. 2 illustrates a block diagram of an apparatus in accordance with an example embodiment of the present invention;

FIG. 3 is a signaling diagram in accordance with one embodiment of the present invention in which a packet switched domain radio bearer is released;

FIG. 4 is a signaling diagram in accordance with one embodiment of the present invention in which all packet switched domain radio bearers, other than the signaling radio bearer, in a core network domain are released;

FIG. 5 is a signaling diagram in accordance with one embodiment of the present invention in which a packet switched domain radio bearer is re-established;

FIG. 6 is a signaling diagram in accordance with one embodiment of the present invention in which a packet switched domain radio bearer in a core network domain is re-established;

FIG. 7 is a flowchart illustrating operations performed in accordance with an example embodiment of the present invention from the perspective of a mobile terminal; and

FIG. 8 is a flowchart illustrating operations performed in accordance with an example embodiment of the present invention from the perspective of a network entity.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

At least some mobile terminals may support multiple connections, such as multiple connections in either a circuit switched domain, a packet switched domain or both. In some instances, a mobile terminal may support concurrent connections with both the circuit switched domain and the packet switched domain. For example, a mobile terminal may support concurrent connections with both the circuit switched domain and the packet switched domain in order to obtain different services, such as voice communication services via a circuit switched voice call and file downloading or other file transfer services, internet access or the like via a packet switched data call. As noted above, the packet switched domain may allow for the communication of larger transport blocks between the mobile terminal and the network than in the circuit switched domain. Accordingly, it is generally more likely that an unrecoverable error, such as an RLC unrecoverable error, will occur in the packet switched domain than in the circuit switched domain.

An analogous situation may occur in an instance in which a mobile terminal establishes multiple connections within the same domain in order to obtain different services, such as in an instance in which a mobile terminal concurrently supports both a Voice over Internet Protocol (VoIP) call and a packet switched data call via first and second packet switched domain radio access bearers, respectively. In this instance, both services are provided within the packet switched domain, but the VoIP call will generally utilize much smaller transport blocks than the packet switched data call such that it is more likely that an unrecoverable error will occur in conjunction with the packet switched data call than with the VoIP call even though both services are supported within the packet switched domain.

In order to avoid the temporary disruption or, in some instances, termination of the service supported by the radio bearer that did not experience an unrecoverable error that may otherwise occur in response to a cell update procedure instituted in response to an unrecoverable error on the other radio bearer, such as described by Section 25.331, Subclause 8.3.1 of the 3GPP specification, a method, apparatus and computer program product of an example embodiment of the present invention permit the unrecoverable error to be addressed without initiating a cell update procedure and, as a result, without disrupting or terminating the service supported by the radio access bearer that did not experience an unrecoverable error, such as the service utilizing smaller transport block sizes. As such, for example, the service supported by the radio access bearer that did not experience an unrecoverable error can continue uninterrupted even though another radio bearer has experienced an unrecoverable error. For purposes of illustration but not of limitation, the method, apparatus and computer program product of an example embodiment will primarily be described hereinafter in regards to a scenario in which connections are established in both the circuit switched and the packet switched domains for supporting different services utilizing different transport block sizes. However, the method, apparatus and computer program product is equally applicable in scenarios in which multiple connections are established within the same domain, such as either the circuit switched domain or the packet switched domain, for supporting different services, e.g. a VoIP call and a packet switched data call.

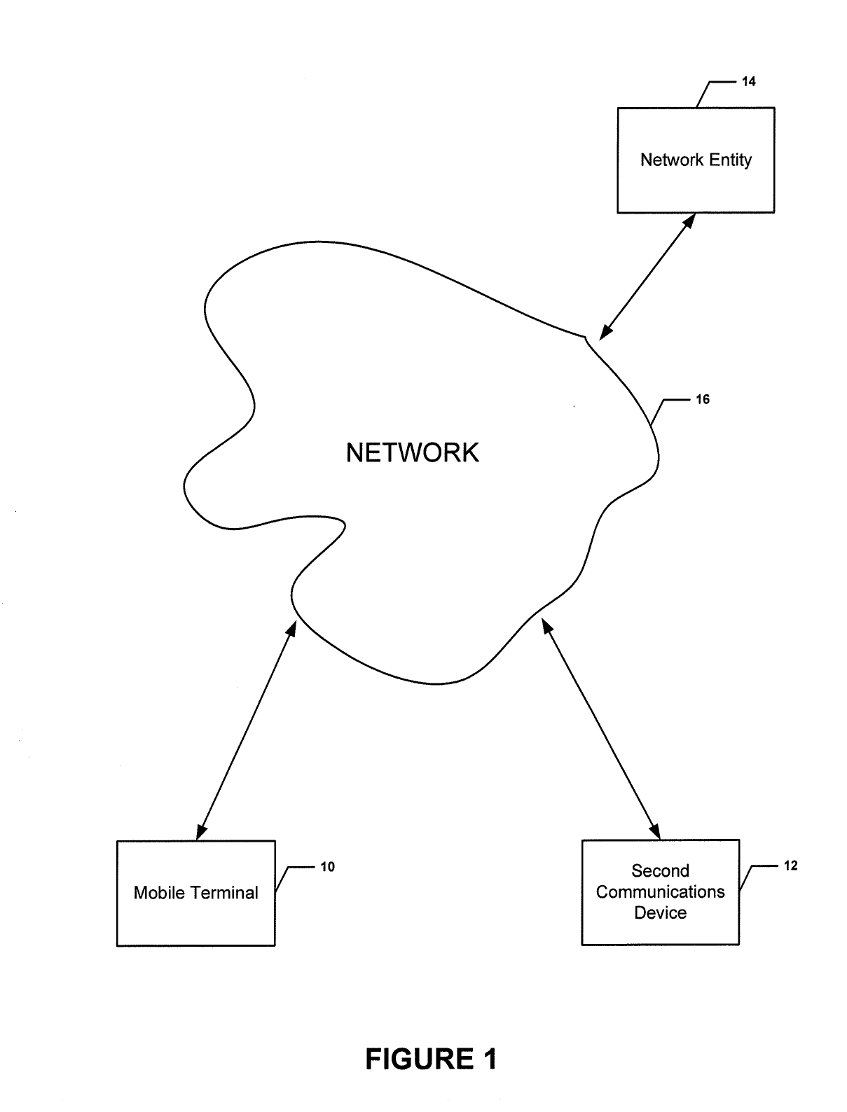

In order to establish multiple connections, such as connections in both the circuit switched domain and the packet switched domain, a mobile terminal 10 may be in communication with a network 16 including a network entity 14, such as a RNC (radio network controller). In this regard, FIG. 1 illustrates a generic system diagram in which a device such as a mobile terminal 10 is shown in an example communication environment in which embodiments of the present invention may be employed. As shown in FIG. 1, an embodiment of a system in accordance with an example embodiment of the present invention may include a first communication device (e.g., mobile terminal 10) and a second communication device 12 that may each be capable of communication with a network 16 (e.g., a core network). The second communication device is provided as an example to illustrate potential multiplicity with respect to instances of other devices that may be included in the network and that may practice example embodiments. The communications devices of the system may be able to communicate with network devices, such as the network entity, or with each other via the network. In some cases, the communication devices may be provided with access to the network via a base station or other communication node (e.g., evolved node B (eNB), node B or other base station or access point).

The network 16 may include a collection of various different nodes, devices or functions including, for example, network entity 14 that may be in communication with each other via corresponding wired and/or wireless interfaces. As such, the illustration of FIG. 1 should be understood to be an example of a broad view of certain elements of the system and not an all inclusive or detailed view of the system or the network. One or more communication terminals such as the mobile terminal 10 and the second communication device 12 may be in communication with each other or other devices via the network. In some cases, each of the communication terminals may include an antenna or antennas for transmitting signals to and for receiving signals from a base site. The base site could be, for example, a base station that is a part of one or more cellular or mobile networks or public land mobile networks (PLMNs). In turn, other devices such as processing devices (e.g., personal computers, server computers or the like) may be coupled to the mobile terminal and/or the second communication device via the network. In some embodiments, the network may employ one or more mobile access mechanisms such as wideband code division multiple access (W-CDMA), CDMA2000, global system for mobile communications (GSM), general packet radio service (GPRS), long term evolution (LTE), LTE Advanced (LTE-A) and/or the like.

In some example embodiments, the mobile terminal 10 (and/or the second communication device 12) may be a mobile communication device such as, for example, a mobile telephone, portable digital assistant (PDA), pager, laptop computer, Universal Serial Bus (USB) dongle, data card, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 16.

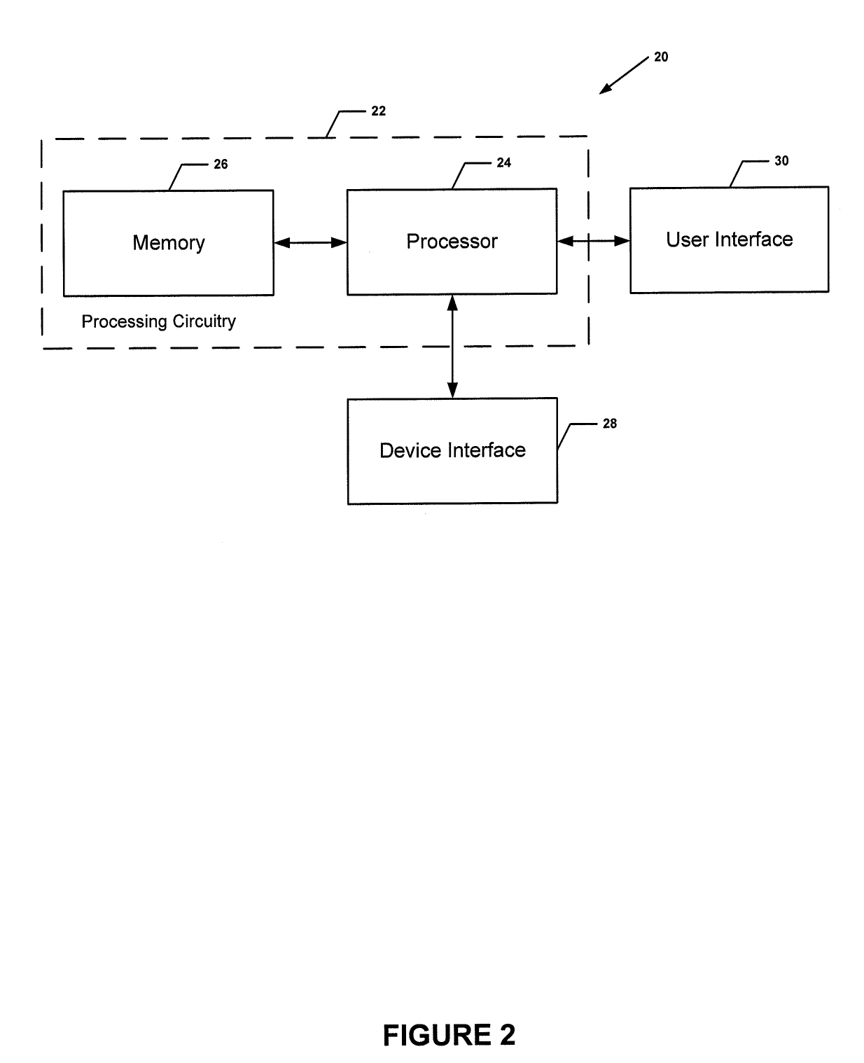

Both the mobile terminal 10 and the network entity 14 may be embodied as or otherwise include an apparatus 20 as generically represented by the block diagram of FIG. 2. In this regard, the apparatus may be configured to permit unrecoverable errors in the packet switched domain to be addressed without initiating a cell update procedure and, as a result, without interrupting or terminating a concurrent connection in the circuit switched domain. An example embodiment of the invention will be described hereinafter with reference to the apparatus of FIG. 2. The apparatus may be employed, for example, by a mobile terminal and/or a network entity. However, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal, while in the context of the network entity 14, the processing circuitry may be embodied as a server, computer, workstation or the like. While the apparatus in the context of a mobile terminal will commonly include a user interface, the apparatus in the context of the network entity may not include a user interface or the user interface may be disposed at another device (e.g., at a computer terminal or client device) that may be in communication with the processing circuitry via the device interface and/or a network (e.g., network 16).

The user interface 30 (if implemented) may be in communication with the processing circuitry 22 to receive an indication of a user input at the user interface and/or to provide an audible, visual, mechanical or other output to the user. As such, the user interface in the context of a mobile terminal 10 may include, for example, a keyboard, a mouse, a joystick, a display, a touch screen, a microphone, a speaker, and/or other input/output mechanisms. In an example embodiment in which the apparatus is embodied at a server or other network device (e.g., the network entity 14), the user interface may be fully implemented, limited, remotely located or eliminated.

The device interface 28 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), USB, Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with exemplary embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

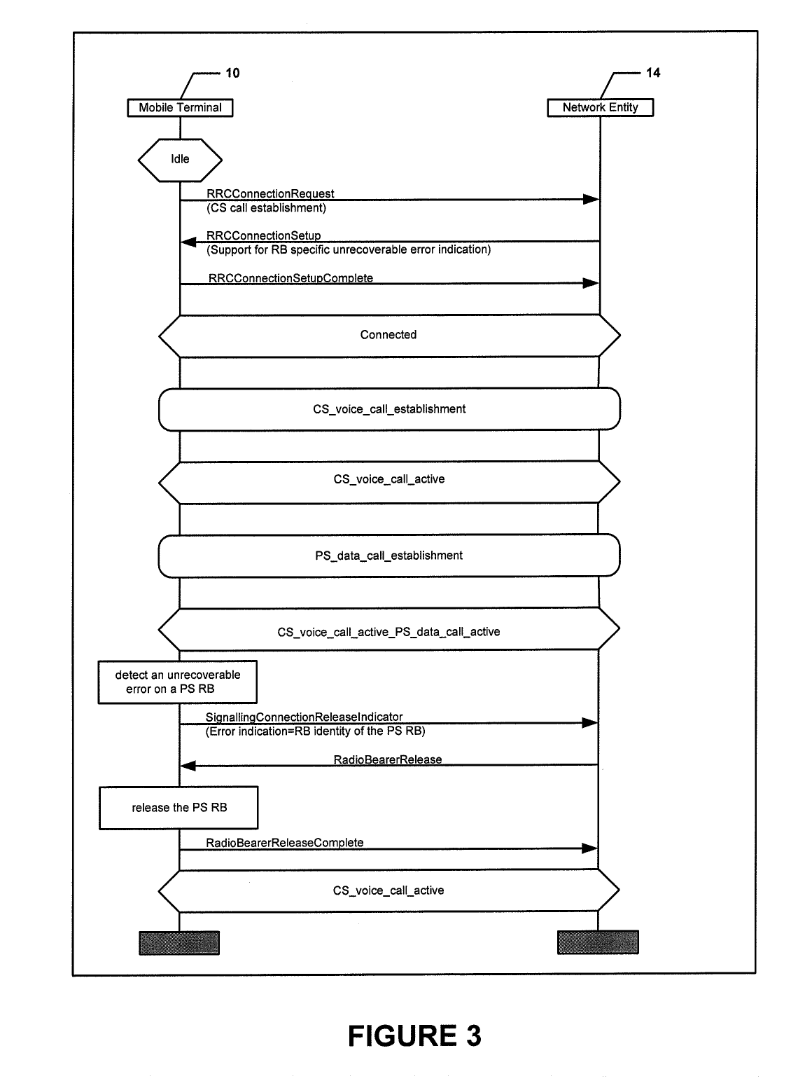

As noted above, a mobile terminal 10 may concurrently establish and support multiple connections in the same or different domains to support different services, such as connections in both the circuit switched domain and the packet switched domain. While the connections may be established and supported in various manners, FIG. 3 illustrates one embodiment in which a mobile terminal that is initially in an idle state transmits a message to the network entity 14 requesting the establishment of a connection. In one embodiment, for example, the mobile terminal may transmit an RRCConnectionRequest message to the network entity to request the establishment of a radio resource control (RRC) connection. The network entity and the mobile terminal may then exchange messages to complete the connection, such as by exchanging an RRCConnectionSetup message and an RRCConnectionSetupComplete message as shown in FIG. 3. During the exchange of messages, the network entity may transmit a message or otherwise provide an indication to the mobile terminal that the network entity supports unrecoverable error reporting. Indeed, in the embodiment illustrated in FIG. 3, the network entity may include an indication in the RRCConnectionSetup message that the network entity supports unrecoverable error reporting including an indication of the specific radio bearer (RB) that suffered the unrecoverable error. Or in another embodiment, the network entity may include an indication in another message, such as a handover command, an RRC reconfiguration message or a downlink RRC message exchanged during the CS call establishment or PS call establishment that the network entity supports unrecoverable error reporting including an indication of the specific radio bearer (RB) that suffered the unrecoverable error.

Based upon the exchange of setup messages, a connection is established between the mobile terminal 10 and the network entity 14. The connection may then support the exchange of messages necessary for call establishment in one or both of the circuit switched domain and the packet switched domain. For example, a circuit switched voice call and a packet switched data call may be established such that both a circuit switched voice call and a packet switched data call may be concurrently active. Although not shown in FIG. 3, the establishment of these calls generally requires the exchange of some non-access stratum (NAS) and RRC messages between the mobile terminal and the network via the connection that was previously established. As shown in FIG. 3, an unrecoverable error may be detected by the mobile terminal in the packet switched domain, such as on a packet switched radio bearer. The mobile terminal may then transmit a message to the network entity indicating that an unrecoverable error has been experienced in the packet switched domain and, in one embodiment, providing the identity of the packet switched radio bearer that experienced the unrecoverable error. In the embodiment illustrated in FIG. 3, the mobile terminal may advise the network entity of the unrecoverable error by transmitting a SignalingConnectionReleaseIndication message to the network entity, although other uplink RRC messages may be employed in other embodiments. In one embodiment, the SignalingConnectionReleaseIndication message may include the identity of the packet switched radio bearer that experienced the unrecoverable error. The network entity of this embodiment may then instruct the mobile terminal to release the packet switched radio bearer that experienced the unrecoverable error. For example, the network entity of the embodiment illustrated in FIG. 3 may transmit a RadioBearerRelease message to the mobile terminal instructing the mobile terminal to release the packet switched domain radio bearer that experienced the unrecoverable error. In this regard, the RadioBearerRelease message may include the radio bearer identity in the packet switched domain to be released. In response, the mobile terminal may release the packet switched domain radio bearer that experienced the unrecoverable error and, in one embodiment, may advise the network entity that the release of the packet switched domain radio bearer is complete, such as by issuing a RadioBearerReleaseComplete message in the embodiment of FIG. 3.

By identifying the specific packet switched domain radio bearer that experienced the unrecoverable error and by exchanging messages between the mobile terminal 10 and the network entity 14 that results in the specific packet switched domain radio bearer that experienced the unrecoverable error being released, the packet switched domain radio bearer that experienced the unrecoverable error may be released without initiating a cell update procedure. As a result, the other connection, that is, the connection in the circuit switched domain, such as a circuit switched voice call, may remain active as shown in FIG. 3 and is not temporarily interrupted or terminated as may otherwise have occurred if a cell update procedure had been initiated. Thus, the connection in the circuit switched domain can continue uninterrupted notwithstanding the unrecoverable error experienced in the packet switched domain.

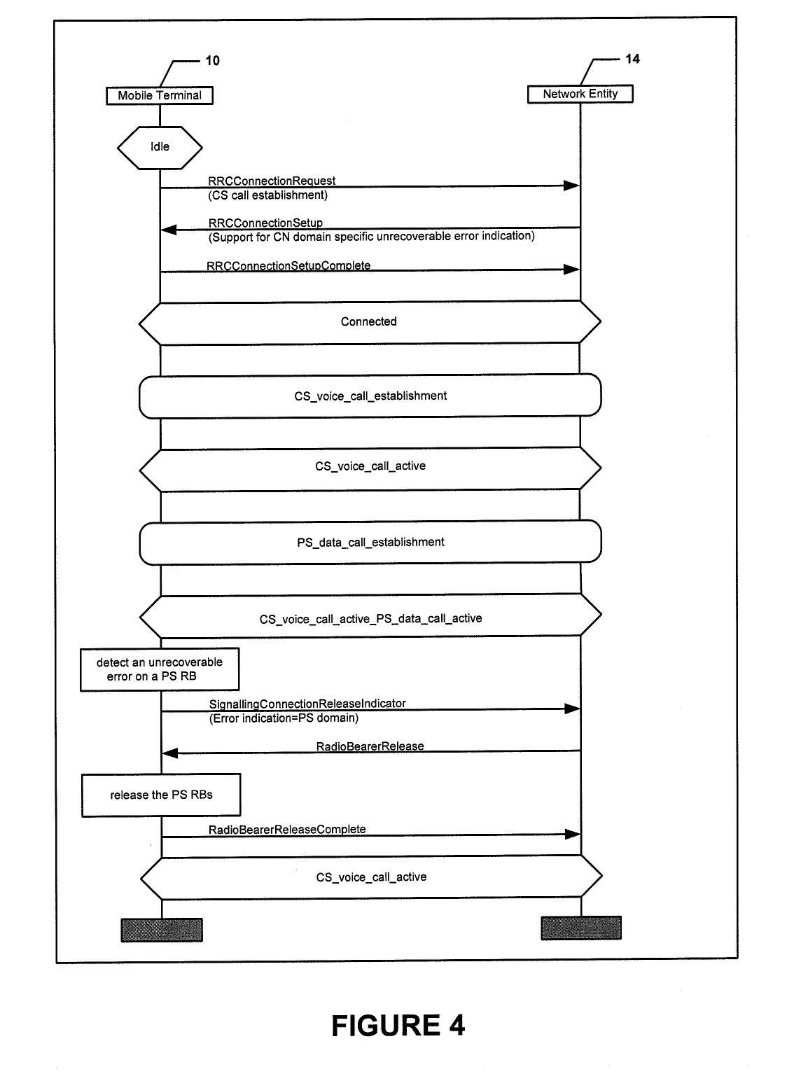

The method, apparatus computer program product of embodiments of the present invention may address the unrecoverable error experienced on one connection, such as the connection in the packet switched domain, without interrupting the other connection, such as the connection in the circuit switched domain, in other manners. For example, FIG. 4 illustrates the signaling that occurs between a mobile terminal 10 and a network entity 14 in another embodiment in which an unrecoverable error is experienced in the packet switched domain. As in the embodiment of FIG. 3, both a circuit switched voice call and a packet switched data call may be established and active at the same time. In response to the detection of an unrecoverable error on a packet switched radio bearer, the mobile terminal may advise the network entity of the unrecoverable error, such as by transmitting a SignalingConnectionReleaseIndication message or other uplink RRC message to the network entity. While the mobile terminal of the embodiment of FIG. 3 provides the network entity with the identity of the specific packet switched domain radio bearer that experienced the unrecoverable error, the mobile terminal of the embodiment of FIG. 4 may advise the network entity of the packet switched domain that experienced the unrecoverable error, but need not advise the network entity of the specific radio bearer. The network entity may then instruct the mobile terminal to release the packet switched domain radio bearer(s) that might experience the unrecoverable error, such as by issuing a RadioBearerRelease message. Unlike the embodiment of FIG. 3 in which the network entity indicated the specific radio bearer that experienced the unrecoverable error that was to be released, the network entity of the embodiment of FIG. 4 may indicate that all of the radio bearers associated with the core network domain with which the radio bearer that experienced the unrecoverable error is associated, that is, the packet switched domain in this example, are to be released with the exception of the signaling radio bearer, such as the radio bearer that is utilized to transmit radio resource control (RRC) and NAS messages to the network 16. For example, the network entity may issue a RadioBearerRelease instruction that provides the identities of the radio bearers associated with the core network domain including, generally among others, the identity of the radio bearer that experienced the unrecoverable error. In response the mobile terminal may release the radio bearers in the core network domain identified by the network entity with the exception of the signaling radio bearer. The mobile terminal of this embodiment may therefore again release the packet switched domain radio bearer that experienced the unrecoverable error, generally along with other radio bearers associated with the same core network domain. The mobile terminal may then advise the network entity that the release of the radio bearers is complete, such as by issuing a RadioBearerReleaseComplete message.

As before, the packet switched domain radio bearer that experienced the unrecoverable error may be released while the connection in the circuit switched domain, such as the circuit switched voice call, remains active and is not interrupted by the release of the packet switched domain radio bearer. Unlike the embodiment of FIG. 3, however, the embodiment of FIG. 4 releases not only the specific packet switched domain radio bearer that experienced the unrecoverable error, but all of the packet switched domain radio bearers in the core network domain that includes or is otherwise associated with the packet switched domain radio bearer that experienced the unrecoverable error, other than the signaling radio bearer, since all of these radio bearers may have the same quality of service (QoS) characteristics as the radio bearer that experienced the unrecoverable error.

In the foregoing embodiments, the packet switched domain radio bearer that experienced the unrecoverable error was released, either by itself or in combination with other packet switched domain radio bearers associated with the same core network domain, while maintaining the connection in the circuit switched domain without interruption or termination. In other embodiments, however, the packet switched domain radio bearer that experienced the unrecoverable error may be released, but a process may be undertaken for recovering the connection in the packet switched domain so as to support resumption of the packet switched services.

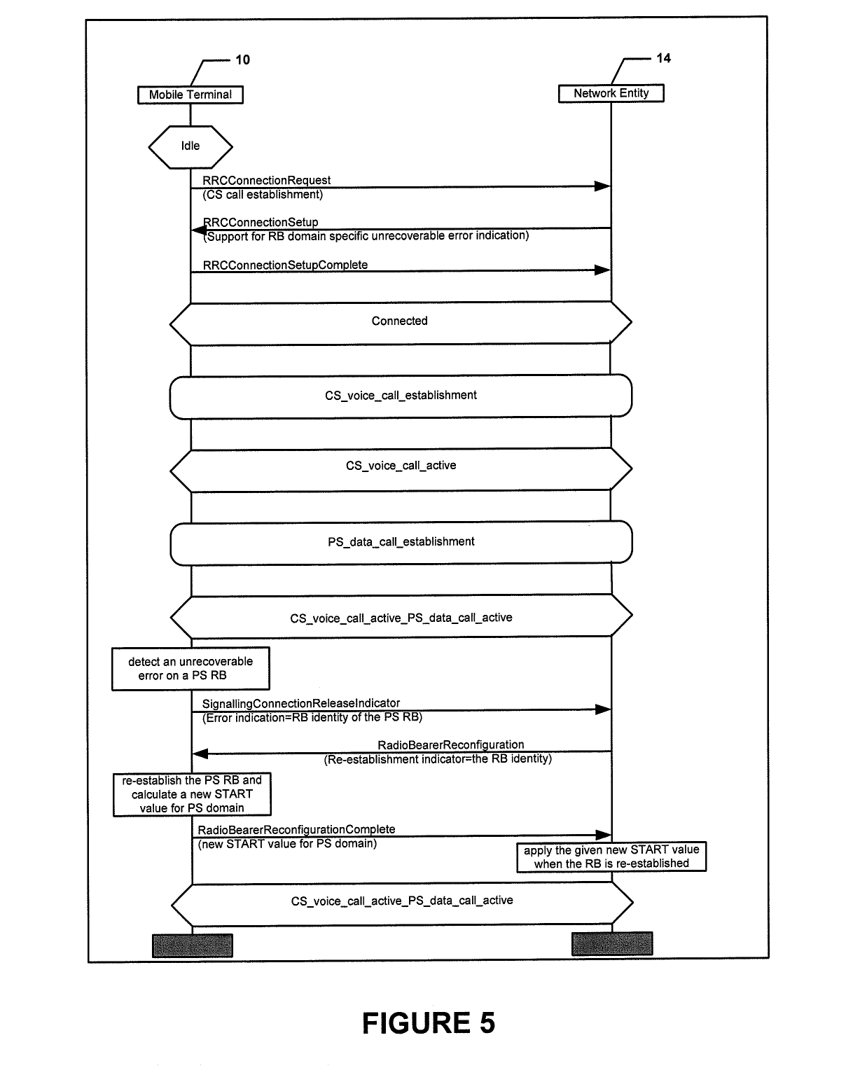

By way of example, FIG. 5 illustrates the signaling sequence between a mobile terminal 10 and a network entity 14 in which a packet switched domain radio bearer that experienced an unrecoverable error may be re-established. In this regard, connections may initially be established in both the circuit switched domain and the packet switched domain so as to support, for example, both an active circuit switched voice call and an active packet switched data call as described above in conjunction with the embodiment of FIG. 3. As also described above in conjunction with the embodiment of FIG. 3, the mobile terminal may detect an unrecoverable error on the packet switched domain radio bearer. The mobile terminal may then advise the network entity of the unrecoverable error and may identify the packet switched domain radio bearer that experienced the unrecoverable error. Unlike the embodiments of FIGS. 3 and 4 in which the network entity would then instruct the mobile terminal to simply release at least the packet switched domain radio bearer that experienced the unrecoverable error, the network entity of the embodiment of FIG. 5 may instruct the mobile terminal to re-establish a connection with a packet switched domain radio bearer, such as by issuing an RRC reconfiguration message, such as a RadioBearerReconfiguration message. In this regard, the network entity may identify the packet switched domain radio bearer with which a connection should be re-established. In at least some embodiments, the packet switched domain radio bearer with which the mobile terminal is instructed to re-establish is the radio bearer that previously experienced the unrecoverable error. In response to the network instruction to re-establish a connection, the mobile terminal may re-establish the packet switched domain radio bearer and may determine a new START value for the core network domain associated with the re-established radio bearer. In this regard, the START value may be used for initializing the HFN (Hyper Frame Number) value of the Count-C value for the radio bearer to be re-established. The mobile terminal may then advise the network entity that the re-establishment of the radio bearer is complete and may inform the network entity of the new START value for the core network domain associated with the re-established radio bearer. In the embodiment of FIG. 5, for example, the mobile terminal may issue a RadioBearerRconfigurationComplete message that includes the new START value for the core network domain associated with the re-established radio bearer. The network entity may then apply the new START value for the COUNT-C initialization of the re-established radio bearer. While the connection with the circuit switched domain remains uninterrupted by the unrecoverable error experienced in the packet switched domain such that a circuit switched voice call, for example, remains active as described in conjunction with the embodiments of FIGS. 3 and 4, the method, apparatus and computer program product of the embodiment of FIG. 5 also permit the re-establishment of the radio bearer associated with the packet switched domain such that a packet switched data call, for example, may again be active once the unrecoverable error has been appropriately handled as described above.

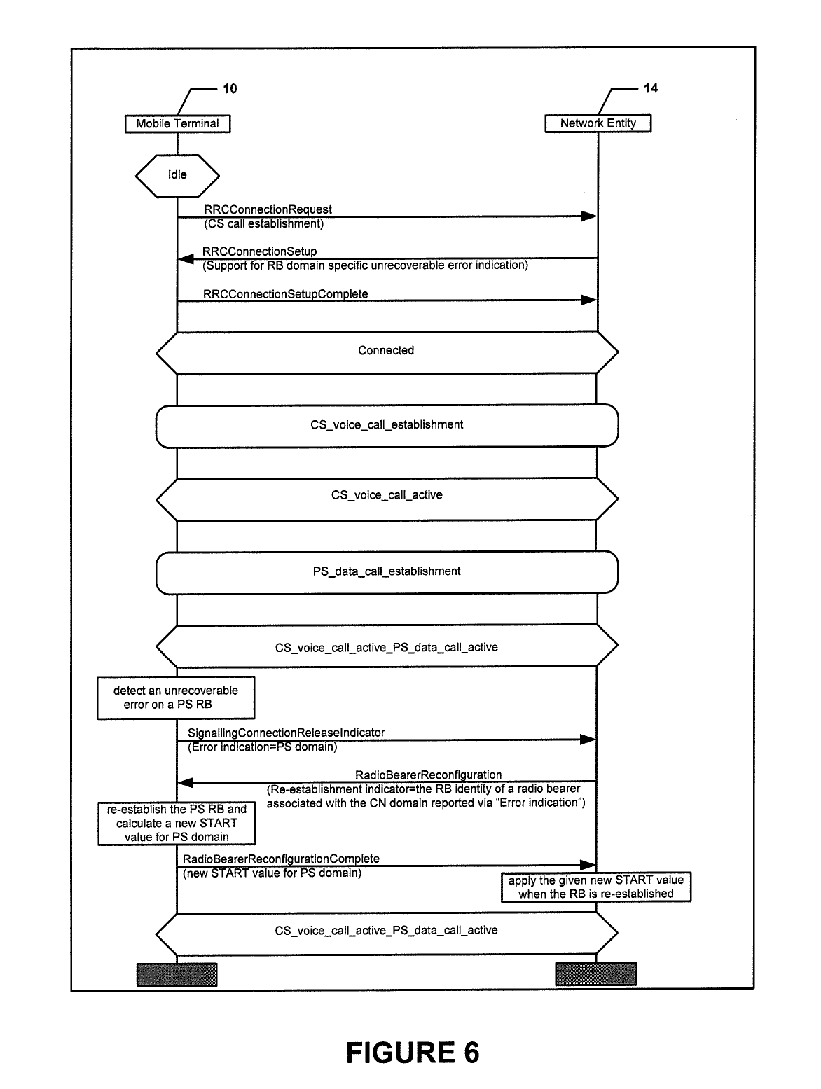

As described above in conjunction with FIG. 4, some embodiments may release not only the specific packet switched domain radio bearer that experienced the unrecoverable error, but each of the radio bearers in the core network domain associated with the radio bearer that experienced the unrecoverable error, other than the signaling radio bearer. Even in these embodiments, however, the connection with the packet switched domain may be recovered. In this regard, FIG. 6 illustrates an embodiment in which connections in both the packet switched domain and the circuit switched domain are initially established such that both a circuit switched voice call and a packet switched data call are concurrently active. As described above in conjunction with the embodiment of FIG. 4, an unrecoverable error on a packet switched domain radio bearer may be detected by the mobile terminal 10 and may be reported to the network entity 14 along with an indication of the core network domain associated with the radio bearer that experienced the unrecoverable error. Unlike the embodiment of FIG. 4, in which the network entity then instructed the mobile terminal to release all of the radio bearers of the core network domain associated with the radio bearer that experienced the unrecoverable error other than the signaling radio bearer, the network entity of the embodiment of FIG. 6 may instruct the mobile terminal to re-establish a connection with the packet switched domain, such as by issuing an RRC reconfiguration message, such as a RadioBearerReconfiguration message to the mobile terminal. As shown in FIG. 6, the network entity of this embodiment may provide an indication to the mobile terminal of the identity of the radio bearer to be re-established, such as by issuing a RadioBearerReconfiguration message that includes the identity of the radio bearer to be re-established. Although the network entity may identify any of a variety of radio bearers within the core network domain to be re-established, the network entity of one embodiment may identify the same radio bearer that previously experienced the unrecoverable error as the packet switched radio bearer that should be re-established. The mobile terminal may then re-establish the radio bearer and determine a new START value for the core network domain associated with the re-established radio bearer. The mobile terminal may also advise the network entity that the reconfiguration process is complete and may provide the new START value for the core network domain associated with the re-established radio bearer to the network entity. In the illustrated embodiment, for example, the mobile terminal may issue a RadioBearerReconfigurationComplete message to the network entity that includes the new START value for the core network domain associated with the re-established radio bearer. The network may then apply the new START value in conjunction with the re-established radio bearer.

As described above in conjunction with the embodiment of FIG. 5, the connection with the circuit switched domain, such as a circuit switched voice call, remains active with no interruption or termination occurring as a result of the unrecoverable error in the packet switched domain. However, the connection with the packet switched domain is recovered by the embodiment of FIG. 6 such that a packet switched data call, for example, may again be active even though an unrecoverable error may have been experienced on the packet switched domain radio bearer at an earlier point in time which resulted in a disruption, but not a termination, in the delivery of the packet services.

As described above, the mobile terminal 10 may advise the network entity 14 of an unrecoverable error on the packet switched domain radio bearer following the detection of the unrecoverable error. As described in conjunction with the embodiments of FIGS. 3 and 5, the mobile terminal may identify the specific packet switched domain radio bearer that experienced the unrecoverable error. Alternatively, as described above in conjunction with the embodiments of FIGS. 4 and 6, the mobile terminal may advise the network entity of the packet switched domain in which the unrecoverable error was experienced. In either instance, the mobile terminal of one embodiment may also be configured to advise the network entity of the cause of the release of the connection in the packet switched domain. In an instance in which the connection in the packet switched domain experiences an unrecoverable error, the mobile terminal may provide an indication to the network entity that the packet switched domain experienced an unrecoverable error, such as an RLC unrecoverable error. This indication of the cause for issuing the indication may be provided in the same message, such as a SignalingConnectionReleaseIndication message, that identifies the radio bearer that experiences the unrecoverable error or the core network domain associated with the radio bearer that experiences the unrecoverable error, or in another message transmitted by the mobile terminal to the network entity.

Based upon the identification of the cause for issuing the indication such as a SignalingConnectionReleaseIndication message, the network entity 14 may determine the most appropriate manner of proceeding. In an instance in which the cause for issuing the indication such as a SignalingConnectionReleaseIndication message is an unrecoverable error, the network entity may proceed as described above in conjunction with the embodiments of FIGS. 3-6 by releasing the radio bearer that experienced the unrecoverable error, and, in some embodiments, re-establishing the radio bearer that experienced the unrecoverable error. However, if the cause for issuing the indication, such as a SignalingConnectionReleaseIndication message is something other than an unrecoverable error, the network entity may be configured to proceed in a different fashion. For example, a radio bearer that supported a packet switched data call may be released in an instance in which the mobile terminal has no additional data to be transmitted. In this instance, the indication of the cause may advise the network entity that the mobile terminal has no additional data to be transmitted at this point in time, such that the network entity need not try to re-establish the connection.

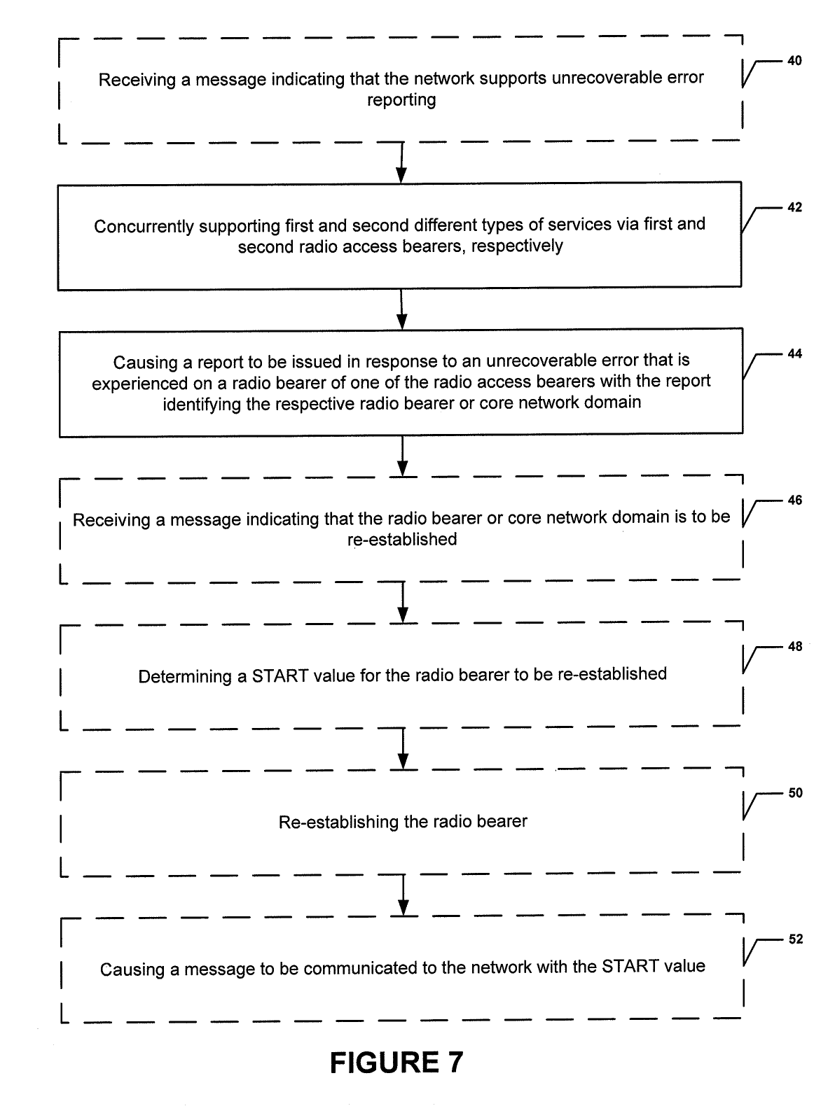

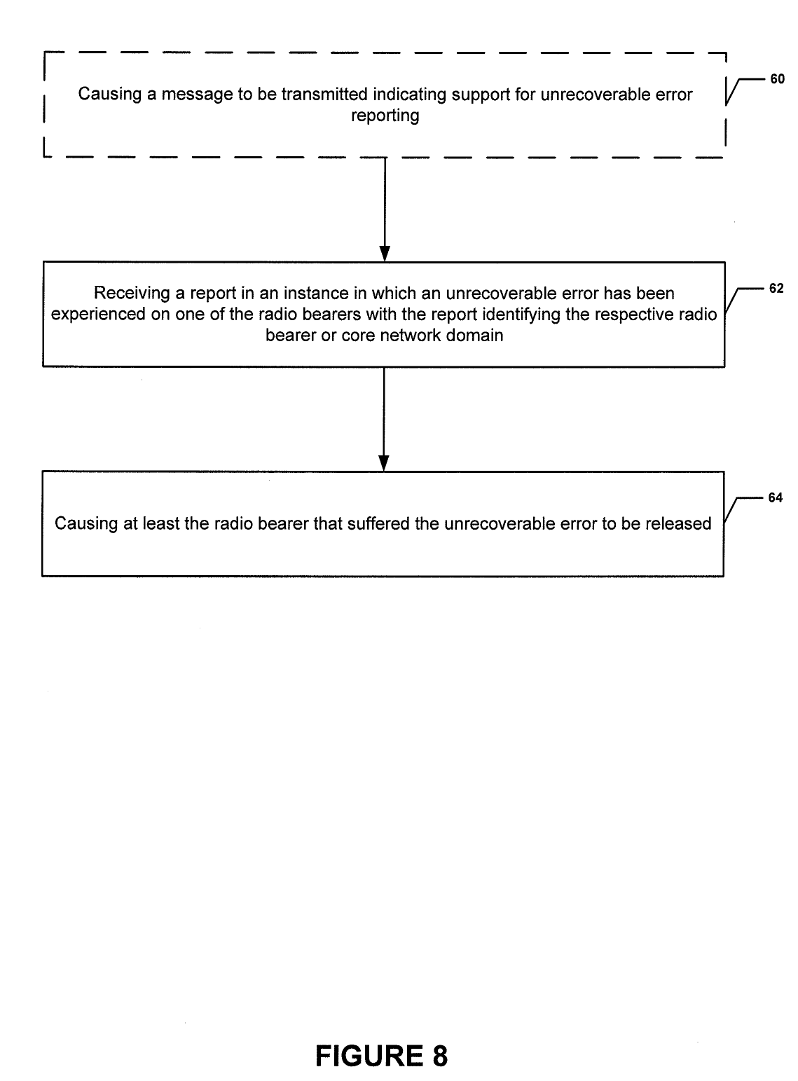

Although examples of the signaling between the mobile terminal 10 and the network entity 14 in conjunction with various embodiments of the present invention have been described above and illustrated in FIGS. 3-6, the operations performed from the perspective of the mobile terminal are also shown in FIG. 7 and the operations performed from the perspective of the network entity are also shown in FIG. 8. In contrast to the embodiments of FIG. 3-6 which were described for the purpose of example in conjunction with the establishment of connections in both the circuit switched domain and the packet switched domain, the embodiments of FIGS. 7 and 8 are described more generically to illustrate the applicability of the method, apparatus and computer program product of example embodiments of the present invention to scenarios in which multiple connections established in either the same or different domains so as to support different services, such as a VoIP call and a packet switched data call that are both supported within the packet switched domain. In this regard, FIGS. 7 and 8 are flowcharts of a system, method and program product according to example embodiments of the invention taken from the perspective of the mobile terminal and the network entity, respectively. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Returning now to FIG. 7, the mobile terminal 10 may optionally include means, such as the device interface 28, the processor 24, the processing circuitry 22 or the like, for receiving a message indicating that the network supports unrecoverable error reporting. In the embodiments of FIGS. 3-6, an RRCConnectionSetup message may be received from the network entity 14 indicating network support for unrecoverable error reporting. See block 40. However, other downlink RRC messages, such as those utilized during CS call setup or PS call setup, may alternatively indicate the network support for unrecoverable error reporting. The mobile terminal may also include means, such as the device interface, the processor, the processing circuitry or the like, for concurrently supporting first and second different types of services via first and second radio access bearers, respectively. See block 42. The first and second different types of services may be provided by different domains, such as a circuit switched voice call and a packet switched data call as described above. Alternatively, the first and second different types of services may be provided within the same domain, such as a VoIP call and a packet switched data call that are both provided within the packet switched domain. Additionally, a radio access bearer may include one or more radio bearers since, for example, the connection for a circuit switched voice may comprise a radio access bearer having a set of three radio bearers. In an instance in which an unrecoverable error is experienced on a radio bearer of one of the radio access bearers, such as the radio bearer supporting the service that utilizes the largest transport block size, the mobile terminal may include means, such as the processor, the processing circuitry, the device interface or the like, for causing a report to be issued identifying the respective radio bearer or core network domain that experienced the unrecoverable error. See block 44. In one embodiment, the mobile terminal may also optionally include means, such as the processor, the processing circuitry or the like, for receiving a message from the network indicating that the radio bearer or the core network domain is to be re-established. See block 46. In this embodiment, the mobile terminal may also include means, such as the processor, the processing circuitry, the device interface or the like, for re-establishing the radio bearer and means, such as the processor, the processing circuitry or the like, for determining a START value for the core network domain associated with the radio bearer that is re-established. See blocks 48 and 50. The radio bearer that is re-established may be the same radio bearer that previously experienced an unrecoverable error or another radio bearer associated with the same core network domain. The mobile terminal of this embodiment may also include means, such as the processor, the processing circuitry, the device interface or the like, for causing a message to be communicated to the network with the START value. See block 52. The mobile terminal of this embodiment may further include means, such as the processor, the processing circuitry, the device interface or the like, for then re-establishing the radio bearer.

According to this embodiment, the mobile terminal 10 may appropriately handle an unrecoverable error that is experienced on a radio bearer of one of the radio access bearers without causing an call update procedure to be initiated and, as a result, without interrupting or otherwise disturbing the service provided via the other radio access bearer such that a circuit switched voice call or a VoIP, for example, will experience uninterrupted service notwithstanding the unrecoverable error experienced during a concurrent packet switched data call. Moreover, in some embodiments, the radio bearer supporting the service that experienced the unrecoverable error may be re-established so as to recover, for example, the packet switched data call.

From the perspective of the network entity 14, FIG. 8 illustrates an example of the operations that may be performed in order to handle an unrecoverable error on a radio bearer of one of multiple radio access bearers via which a mobile terminal was providing different types of services without interrupting the service provided via the other radio access bearer that has not experienced an unrecoverable error. As noted above, the first and second different types of services may be provided by different domains, such as a circuit switched voice call and a packet switched data call. Alternatively, the first and second different types of services may be provided within the same domain, such as a VoIP call and a packet switched data call that are both provided within the packet switched domain. In the embodiment of FIG. 8, the network entity may optionally include means, such as the processor 24, the processing circuitry 22, the device interface 28 or the like, for causing a message to be transmitted to the mobile terminal 10 indicating support by the network for unrecoverable error reporting. See block 60. In the embodiments of FIGS. 3-6 for example, the network entity may issue an RRCConnectionSetup message that indicates to the mobile terminal that the network entity supports unrecoverable error reporting. However, other downlink RRC messages, such as those utilized during CS call setup or PS call setup, may alternatively indicate the network support for unrecoverable error reporting. In response to an unrecoverable error experienced on a radio bearer of one of the radio access bearers, the network entity may include means, such as the processor, the processing circuitry, the device interface or the like, for receiving a report in an instance in which a mobile terminal that has been concurrently supporting first and second different types of services via first and second radio access bearers, respectively, has experienced an unrecoverable error. See block 62. The report may identify the respective radio bearer or core network domain that experienced the unrecoverable error. The network entity may also include means, such as the processor, the processing circuitry or the like, for causing at least the radio bearer that suffered the unrecoverable error to be released, and, in some embodiments, to cause all of the radio bearers in the core network with which the radio bearer that experienced the unrecoverable error is associated to be released. See block 64.

In one embodiment in which the network entity 14 also supports recovery of a radio bearer following an unrecoverable error, the network entity may include means, such as the processor 24, the processing circuitry 22, the device interface 28 or the like, for optionally receiving a message with a START value for the core network domain associated with a radio bearer to be re-established. The network entity of this embodiment may also include means, such as the processor, the processing circuitry or the like, for applying the START value to the core network domain associated with the re-established radio bearer. As such, the network entity of some embodiments of the present invention also permit unrecoverable errors on a radio bearer to be appropriately handled, such as by being released then and by being recovered, without adversely affecting, such as by interrupting, disturbing or terminating, another service provided concurrently via another radio bearer.

In some embodiments, certain ones of the operations above may be modified or further amplified. For example, FIGS. 7 and 8 illustrate, by dashed lines, additional optional operations that may be included in some embodiments, but not other embodiments. It should be appreciated that each of these optional operations may be included with the other operations either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
concurrently supporting first and second different types of services via first and second radio access bearers, respectively; and
causing a report to be issued to a network in response to an unrecoverable error that is experienced on a radio bearer of one of the radio access bearers, wherein the report identifies at least one of the radio bearer that experienced the unrecoverable error or a core network domain associated with the radio bearer that experienced the unrecoverable error, and wherein the report is caused to be issued without initiating a cell update procedure.

2. A method according to claim 1 further comprising re-establishing a radio bearer following issuance of the report to the network.

3. A method according to claim 2 further comprising determining a START value for the radio bearer that is re-established and causing a message to be communicated to the network that includes the START value.

4. A method according to claim 2 further comprising receiving a message from the network indicating the radio bearer to be re-established, wherein the message is received from the network prior to re-establishing the radio bearer.

5. A method according to claim 2 further comprising receiving a message from the network indicating the core network domain associated with the radio bearer to be re-established, wherein the message is received from the network prior to re-establishing the radio bearer.

6. A method according to claim 1 further comprising receiving a message from the network indicating that the network supports unrecoverable error reporting, wherein the message is received from the network prior to causing the report to be issued.

7. A method according to claim 1 wherein causing the report to be issued comprises causing the report to be issued so as to also identify a cause of the unrecoverable error.

8. An apparatus comprising processing circuitry configured at least to:
concurrently support first and second different types of services via first and second radio access bearers, respectively; and
cause a report to be issued to a network in response to an unrecoverable error that is experienced on a radio bearer of one of the radio access bearers, wherein the report identifies at least one of the radio bearer that experienced the unrecoverable error or a core network domain associated with the radio bearer that experienced the unrecoverable error, and wherein the report is caused to be issued without initiating a cell update procedure.

9. An apparatus according to claim 8 wherein the processing circuitry is further configured to re-establish a radio bearer following issuance of the report to the network.

10. An apparatus according to claim 9 wherein the processing circuitry is further configured to determine a START value for the radio bearer that is re-established and to cause a message to be communicated to the network that includes the START value.

11. An apparatus according to claim 9 wherein the processing circuitry is further configured to receive a message from the network indicating the radio bearer to be re-established, wherein the message is received from the network prior to re-establishing the radio bearer.

12. An apparatus according to claim 9 wherein the processing circuitry is further configured to receive a message from the network indicating the core network domain associated with the radio bearer to be re-established, wherein the message is received from the network prior to re-establishing the radio bearer.

13. An apparatus according to claim 8 wherein the processing circuitry is further configured to receive a message from the network indicating that the network supports unrecoverable error reporting, wherein the message is received from the network prior to causing the report to be issued.

14. An apparatus comprising a processing circuitry configured at least to:
receive a report in an instance in which a mobile terminal that has been concurrently supporting first and second different types of services via first and second radio access bearers, respectively, has experienced an unrecoverable error on a radio bearer of one of the radio access bearers, wherein the report identifies at least one of the radio bearer that experienced the unrecoverable error or a core network domain associated with the radio bearer that experienced the unrecoverable error; and
cause the radio bearer that experienced the unrecoverable error to be released without initiation of a cell update procedure.

15. An apparatus according to claim 14 wherein the processing circuitry being configured to cause the radio bearer that experienced the unrecoverable error to be released comprises being configured to cause all radio bearers, other than a signaling radio bearer, that are associated with the core network domain to be released in an instance in which the report identifies the core network domain.

16. An apparatus according to claim 14 wherein the processing circuitry is further configured to receive a message that includes a START value for a radio bearer to be re-established.

17. An apparatus according to claim 16 wherein the processing circuitry is further configured to apply the START value to the radio bearer that is re-established.

18. An apparatus according to claim 14 wherein the processing circuitry is further configured to cause a message to be communicated to the mobile terminal indicating support for unrecoverable error reporting, wherein the message is caused to be communication prior to receiving the report.

19. An apparatus according to claim 14 wherein the processing circuitry is further configured to cause a message to be communicated to the mobile terminal indicating a radio bearer to be re-established, wherein the message is caused to be communicated prior to re-establishing the radio bearer.

20. An apparatus according to claim 14 wherein the processing circuitry is further configured to cause a message to be communicated to the mobile terminal indicating a core network domain having a radio bearer to be re-established, wherein the message is caused to be communicated prior to re-establishing the radio bearer.
